(19) United States
(12) Patent Application Publication
(10) Pub. No.: US 2026/0353425 A1
(43) Pub. Date: Nov. 5, 2026

(54) DYNAMIC RADIO FREQUENCY FRONT END

(71) Applicant: QUALCOMM Incorporated, San Diego, CA (US)

(72) Inventors: Igor GUTMAN, Hod HaSharon (IL); Tao LUO, San Diego, CA (US); Mostafa KHOSHNEVISAN, San Diego, CA (US); Wooseok NAM, San Diego, CA (US); Qian ZHANG, Basking Ridge, NJ (US); Junyi LI, Greentown, PA (US)

(21) Appl. No.: 19/195,427

(22) Filed: Apr. 30, 2025

(51) Int. Cl. H04W 72/541; H04W 52/02; H04W 72/11; H04W 72/1273

(52) U.S. Cl. CPC H04W 72/541; H04W 52/0212; H04W 72/11; H04W 72/1273

(57) ABSTRACT

This disclosure provides methods, components, devices and systems for dynamic radio frequency front end. For example, a UE may transmit an indication of whether an uplink transmission by the UE has occurred or will occur. The UE may participate in one or more mitigation actions to mitigate an effect of a nonlinear interference associated with the uplink transmission on a scheduled downlink signal that temporally overlaps with the uplink transmission. Additionally, or alternatively, the UE may receive an indication associated with a likelihood that one or more transmissions will occur, where the one or more transmissions temporally overlap with a downlink signal at the UE and are associated with nonlinear interference that potentially overlaps with the downlink signal. The UE may participate in, and receive the downlink signal in accordance with, one or more mitigation actions to mitigate an effect of the nonlinear interference on the downlink signal.

### TECHNICAL FIELD

This disclosure relates generally to wireless communication, and more specifically to systems, devices, methods, and techniques associated with dynamic radio frequency front end.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communication by a user equipment (UE) is described. The method may include transmitting an indication of whether an uplink transmission by the UE has occurred or will occur, where the indication is associated with potential self-interference at the UE and participating in one or more mitigation actions to mitigate, at least partially, an effect of a nonlinear interference associated with the uplink transmission on a scheduled downlink signal that temporally overlaps, at least partially, with the uplink transmission.

A UE for wireless communication is described. The UE may include a processing system that includes processor circuitry and memory circuitry that stores code. The processing system may be configured to cause the UE to transmit an indication of whether an uplink transmission by the UE has occurred or will occur, where the indication is associated with potential self-interference at the UE and participate in one or more mitigation actions to mitigate, at least partially, an effect of a nonlinear interference associated with the uplink transmission on a scheduled downlink signal that temporally overlaps, at least partially, with the uplink transmission.

Another UE for wireless communication is described. The UE may include means for transmitting an indication of whether an uplink transmission by the UE has occurred or will occur, where the indication is associated with potential self-interference at the UE and means for participating in one or more mitigation actions to mitigate, at least partially, an effect of a nonlinear interference associated with the uplink transmission on a scheduled downlink signal that temporally overlaps, at least partially, with the uplink transmission.

A non-transitory computer-readable medium storing code for wireless communication is described. The code may include instructions executable by one or more processors to transmit an indication of whether an uplink transmission by the UE has occurred or will occur, where the indication is associated with potential self-interference at the UE and participate in one or more mitigation actions to mitigate, at least partially, an effect of a nonlinear interference associated with the uplink transmission on a scheduled downlink signal that temporally overlaps, at least partially, with the uplink transmission.

In some examples of the method, UEs, and non-transitory computer-readable medium described herein, the potential self-interference at the UE may be between the uplink transmission by the UE and reception of a downlink reference signal at the UE, the scheduled downlink signal may be the downlink reference signal, and the indication may be associated with one or more channel state information measurements by the UE.

Some examples of the method, UEs, and non-transitory computer-readable medium described herein may further include operations, features, means, or instructions for receiving a configuration indicating a network layer for transmitting the indication, where transmitting the indication may be in accordance with the configuration.

In some examples of the method, UEs, and non-transitory computer-readable medium described herein, the indication indicates a statistical likelihood that the UE will use one or more configured grant occasions and the uplink transmission may be associated with the one or more configured grant occasions.

Some examples of the method, UEs, and non-transitory computer-readable medium described herein may further include operations, features, means, or instructions for receiving, from a network entity, signaling associated with a statistical likelihood of upcoming traffic between the UE and the network entity, where participating in the one or more mitigation actions may be based on the signaling.

In some examples of the method, UEs, and non-transitory computer-readable medium described herein, participating in the one or more mitigation actions may include operations, features, means, or instructions for increasing an instantaneous bandwidth for reception of the scheduled downlink signal, controlling an analog front end setpoint for automatic gain control applied to reception of the scheduled downlink signal, or both based on the indication and the signaling.

A method for wireless communication by a UE is described. The method may include receiving an indication associated with a likelihood that one or more transmissions will occur, where the one or more transmissions are associated with nonlinear interference that potentially overlaps with a downlink signal at the UE, where the downlink signal and at least one of the one or more transmission temporally overlap, at least partially, participating in one or more mitigation actions to mitigate, at least partially, an effect of the nonlinear interference on the downlink signal, and receiving the downlink signal in accordance with the one or more mitigation actions.

A UE for wireless communication is described. The UE may include a processing system that includes processor circuitry and memory circuitry that stores code. The processing system may be configured to cause the UE to receive an indication associated with a likelihood that one or more transmissions will occur, where the one or more transmissions are associated with nonlinear interference that potentially overlaps with a downlink signal at the UE, where the downlink signal and at least one of the one or more transmission temporally overlap, at least partially, participate in one or more mitigation actions to mitigate, at least partially, an effect of the nonlinear interference on the downlink signal, and receive the downlink signal in accordance with the one or more mitigation actions.

Another UE for wireless communication is described. The UE may include means for receiving an indication associated with a likelihood that one or more transmissions will occur, where the one or more transmissions are associated with nonlinear interference that potentially overlaps with a downlink signal at the UE, where the downlink signal and at least one of the one or more transmission temporally overlap, at least partially, means for participating in one or more mitigation actions to mitigate, at least partially, an effect of the nonlinear interference on the downlink signal, and means for receiving the downlink signal in accordance with the one or more mitigation actions.

A non-transitory computer-readable medium storing code for wireless communication is described. The code may include instructions executable by one or more processors to receive an indication associated with a likelihood that one or more transmissions will occur, where the one or more transmissions are associated with nonlinear interference that potentially overlaps with a downlink signal at the UE, where the downlink signal and at least one of the one or more transmission temporally overlap, at least partially, participate in one or more mitigation actions to mitigate, at least partially, an effect of the nonlinear interference on the downlink signal, and receive the downlink signal in accordance with the one or more mitigation actions.

In some examples of the method, UEs, and non-transitory computer-readable medium described herein, the indication includes a frequency offset between the at least one of the one or more transmissions and the downlink signal, a power offset between the at least one of the one or more transmissions and the downlink signal, or both.

In some examples of the method, UEs, and non-transitory computer-readable medium described herein, the one or more transmissions may be downlink transmissions intended for other UEs, uplink transmissions by other UEs, or a combination thereof.

### BRIEF DESCRIPTION OF THE DRAWINGS

FIG. 1 shows an example of a wireless communication system.

FIG. 2 shows an example of a signaling configuration that supports dynamic radio frequency front end.

FIG. 3 shows an example of interference mitigation actions that support dynamic radio frequency front end.

FIG. 4 shows an example of a process flow that supports dynamic radio frequency front end.

FIG. 5 shows an example of a process flow that supports dynamic radio frequency front end.

FIG. 6 shows a block diagram of a processing system that supports dynamic radio frequency front end.

FIG. 7 shows a diagram of a system including a device that supports dynamic radio frequency front end.

FIGS. 8 through 10 show flowcharts illustrating methods that support dynamic radio frequency front end.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, an analog front end (AFE) of a user equipment (UE) may include various nonlinear components that may introduce nonlinear distortion to a received signal. In one example, a transmission by the UE may generate self-interference that affects a downlink signal received at the UE. The UE may set a setpoint of the AFE to absorb self-interference leakage, but the new setpoint of the AFE may increase a noise figure (NF), and a duration associated with adjusting the AFE setpoint may be too long to dynamically adjust the AFE setpoint to account for transmissions associated with potential self-interference. In another example, one or more transmissions between other devices of the wireless communications system may act as jammers and generate nonlinear interference that affects a downlink signal received at the UE. The UE increasing an instantaneous bandwidth (IBW) may allow the UE to mitigate nonlinear interference but may also consume a large quantity of energy, so, in some cases, the UE may operate with a default IBW to avoid excess energy consumption. Signaling providing an advanced indication of potential nonlinear interference between scheduled communications (e.g., between a scheduled downlink signal and an uplink transmission by the UE, between a scheduled downlink signal and a jammer) may allow the UE, the network, or both to dynamically participate in one or more mitigation actions (e.g., adjusting an AFE setpoint, increasing an IBW, dynamically allocating a downlink modulation and coding scheme (MCS) to mitigate the potential nonlinear interference, thereby improving reliability of communications and signal quality while reducing energy consumption.

Aspects of the subject matter described in this disclosure relate to a signaling framework that provides advanced indication of potential nonlinear interference to support dynamic adjustments at a radio frequency front end (RFFE) to mitigate the potential nonlinear interference. For example, a UE may transmit an indication of whether an uplink transmission by the UE has occurred or will occur, where the uplink transmission may cause potential self-interference at the UE. In some examples, the UE may receive, from a network entity, signaling associated with upcoming traffic between the UE and the network entity. The UE may participate in one or more mitigation actions to mitigate (e.g., at least partially) an effect of a nonlinear interference associated with the uplink transmission on a scheduled downlink signal that temporally overlaps (e.g., at least partially) with the uplink transmission based on the indication, the signaling, or both. Additionally, or alternatively, the UE may receive an indication associated with a likelihood of transmissions (e.g., downlink transmissions from a network entity to other UEs, uplink transmissions by other UEs to a network entity, or other transmissions acting as jammers) that are associated with nonlinear interference that potentially overlaps with a downlink signal at the UE, where the downlink signal may temporally overlap with the one or more transmissions. The UE may participate in one or more mitigation actions to mitigate an effect of the nonlinear interference on the downlink signal, and the UE may receive the downlink signal in accordance with the one or more mitigation actions.

Particular aspects of the subject matter described in this disclosure can be implemented to realize one or more of the following potential advantages. In some examples, by providing a signaling framework for advanced indication of potential nonlinear interference, the described techniques can be used to dynamically adjust an RFFE to mitigate nonlinear interference to improve signal quality and communication reliability while reducing energy consumption.

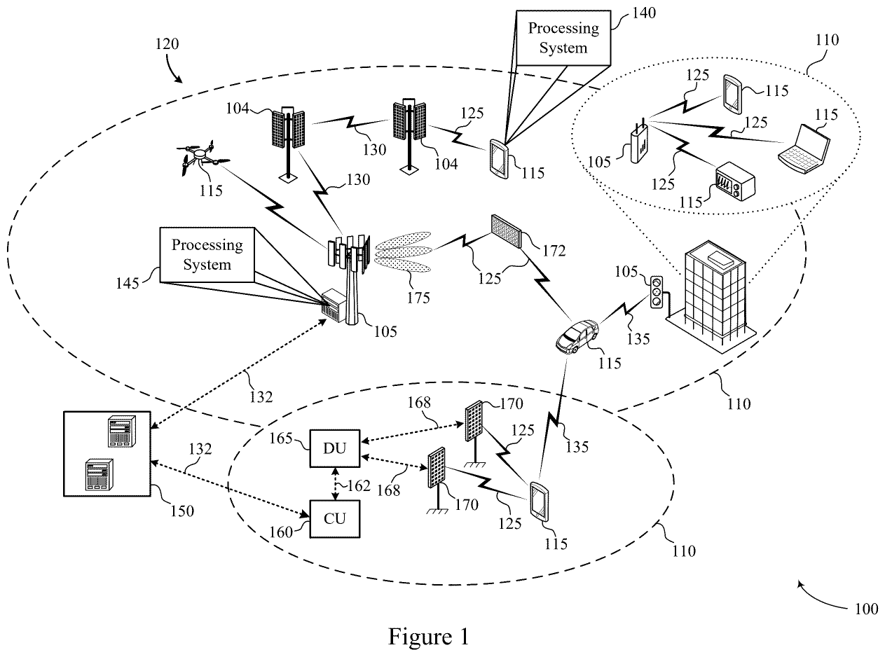

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for dynamic RFFE. For example, a UE 115 may include a processing system 140, and a network entity 105 may include a processing system 145, each of which may be configured to cause the respective device to perform (such as being configured as means for performing) one or more of the described operations. In some cases, a UE 115 may transmit an indication of whether an uplink transmission by the UE has occurred or will occur, where the uplink transmission may cause potential self-interference at the UE 115. In some examples, the UE 115 may receive, from a network entity 105, signaling associated with upcoming traffic between the UE 115 and the network entity 105. The UE 115 may participate in one or more mitigation actions to mitigate (e.g., at least partially) an effect of a nonlinear interference associated with the uplink transmission on a scheduled downlink signal that temporally overlaps (e.g., at least partially) with the uplink transmission based on the indication, the signaling, or both. Additionally, or alternatively, the UE 115 may receive an indication associated with a likelihood of transmissions (e.g., downlink transmissions from a network entity 105 to other UEs 115, uplink transmissions by other UEs 115 to a network entity 105, or other transmissions acting as jammers) that are associated with nonlinear interference that potentially overlaps with a downlink signal at the UE 115, where the downlink signal may temporally overlap with the one or more transmissions. The UE 115 may participate in one or more mitigation actions to mitigate an effect of the nonlinear interference on the downlink signal, and the UE 115 may receive the downlink signal in accordance with the one or more mitigation actions.

By configuring a processing system 140, a processing system 145, or a combination thereof in accordance with the described techniques, the wireless communication system 100 (such as the RAN 120) may support improved reliability of communications, improved signal quality, and reduced energy consumption of UEs 115.

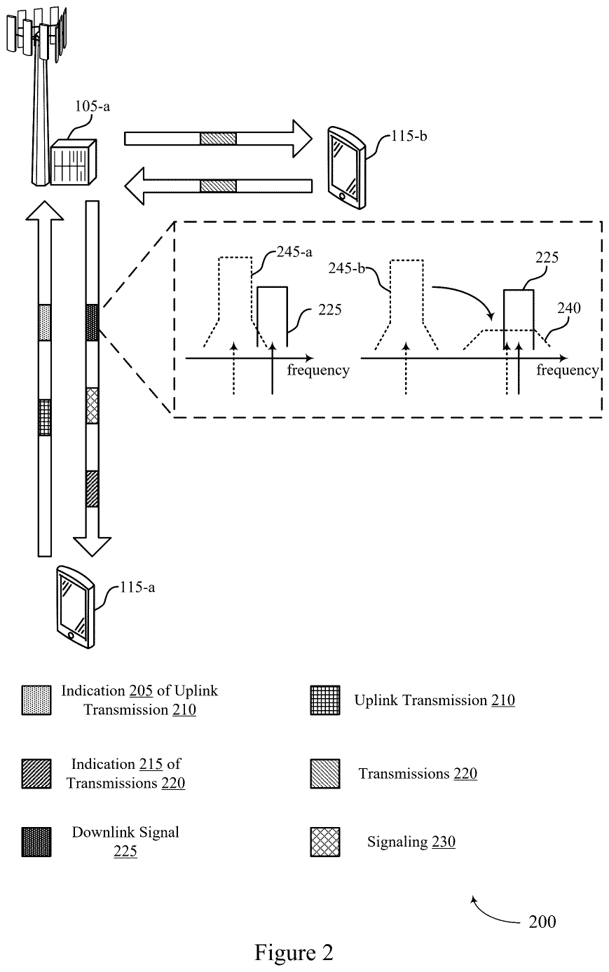

FIG. 2 shows an example of a signaling configuration 200 that supports dynamic RFFE in accordance with one or more aspects of the present disclosure. In some examples, the signaling configuration 200 may implement, or be implemented by, aspects of the wireless communication system 100. For example, the signaling configuration 200 may include a UE 115-a, a UE 115-b, and a network entity 105-a, which may be examples of corresponding devices as described with reference to FIG. 1.

In some examples of the signaling configuration 200, a receiver AFE of the UE 115-a may include various nonlinear components (e.g., amplifiers, active baseband filters, active low-pass filters, mixers, analog-to-digital converters (ADCs), etc.) that may introduce nonlinear distortion to a downlink signal 225 received at the UE 115-a. The various nonlinear components may lead to tradeoffs between performance and energy consumption. For instance, reducing energy (e.g., power) consumption may lead to relaxed linearity of the receiver AFE.

In some cases, interfering signals 245 may introduce nonlinear interference to a downlink signal 225 received at the UE 115-a. For example, an uplink transmission 210 by the UE 115-a may generate self-interference that affects reception of the downlink signal 225. In another example, a jammer, such as transmissions 220 between the network entity 105-a and others UEs 115 (e.g., the UE 115-b), may generate nonlinear interference that affects reception of the downlink signal 225 by the UE 115-a. In some examples, an interfering signal 245-a (e.g., a jammer or self-interference, for example self-interference associated with FDD operations) transmitted in FR1 (e.g., C band) may generate a third-order passive intermodulation product (IM3) leakage that introduces nonlinear interference to reception of a downlink signal 225 in FR1. In other examples, an interfering signal 245-b transmitted in FR1 may generate second-order passive intermodulation product (IM2) leakage 240 that introduces nonlinear interference to reception of a downlink signal 225 in FR3. For instance, the UE 115-a may support FDD, dynamic TDD (D-TDD), and/or full duplex (FD) operations, and the interfering signal 245-b may be an uplink transmission 210 by the UE 115-a that interferes with reception of the downlink signal 225 by the UE 115-a.

In some examples, the UE 115-a, the network entity 105-a, or both may be able to perform various interference mitigation actions to mitigate effects of nonlinear interference on reception of the downlink signal 225 at the UE 115-a. However, these interference mitigation actions may increase energy consumption, and the UE 115-a may be unaware of upcoming signals associated with potential nonlinear interference. For instance, the UE 115-a increasing an ADC rate may allow the UE 115-a to sample the downlink signal 225 as well as adjacent interfering signals, which may allow the UE 115-a to mitigate an effect of the interfering signals (e.g., using a receiver linearizer) and measure the interfering signals to set an AFE setpoint accordingly. However, increasing the ADC rate may also increase energy consumption at the UE 115-a. Similarly, the UE 115-a adjusting an AFE setpoint (e.g., a gain state, a root mean square (RMS) power), for example by adjusting amplification values of analog amplifiers as part of automatic gain control (AGC), may allow the UE 115-a to mitigate an effect of interfering signals, but may increase power consumption at the UE 115-a and may increase a noise floor when interfering signals are absent. In some cases, adjusting an MCS of the downlink signal 225 may mitigate an effect of nonlinear interference on the downlink signal 225 generated by the interfering signals, but the UE 115-a and the network entity 105-a may lack a signaling framework to communicate upcoming signals associated with potential interference so that the network entity 105-a may allocate the MCS of the downlink signal 225 accordingly.

The UE 115-a and the network entity 105-a may be able to improve utilization of the various interference mitigation actions and reduce associated tradeoffs if the UE 115-a and the network entity 105-a have sufficient information on traffic dynamics and potential interference (e.g., including interference from network entities 105 other than the network entity 105-a). For instance, the UE 115-a may be able to appropriately adjust an AFE setpoint if the UE 115-a has information about transmission leakage (e.g., self-interference) or potential jammers, and the UE 115-a may be able to adjust an IBW to measure and mitigate an effect of an interfering signal if the UE 115-a has information on the interfering signal (e.g., a jammer location). Similarly, the network entity 105-a may be able to allocate different MCSs for symbols associated with potential interference (e.g., self-interference or interference from jammers) than symbols without potential interference if the network entity 105-a has information on which symbols are associated with potential interference at the UE 115-a. Accordingly, the techniques described herein may provide a framework for communication of information on potential interfering signals between devices of the signaling configuration 200, and the techniques may support a dynamic RFFE that implements one or more mitigation actions based on the communicated information.

In some examples, a scheduled downlink signal 225 to be received by the UE 115-a may temporally overlap (e.g., at least partially) with an uplink transmission 210 by the UE 115-a. In some cases, the uplink transmission 210 may potentially generate self-interference on reception of the downlink signal 225 at the UE 115-a. To inform mitigation actions to address the potential self-interference, the UE 115-a may transmit an indication 205 of whether an uplink transmission 210 associated with potential self-interference at the UE 115-a has occurred or will occur.

In some implementations, the indication 205 may indicate whether there is an active uplink transmission 210 by the UE 115-a in a slot during which channel quality indicator (CQI) and rank indicator (RI) are measured at the UE 115-a using a downlink reference signal (e.g., including zero power CSI-RS). In such implementations, the indication 205 may allow the network entity 105-a to infer whether a CQI and an RI reported by the UE 115-a include self-interference associated with an uplink transmission 210. In some aspects, a downlink reference signal and an uplink transmission 210 may be in separate carrier frequencies (e.g., an FDD system, a TDD+FDD system, or a TDD+TDD system). The UE 115-a may transmit the indication 205 with a channel state feedback (CSF) report (e.g., including the CQI and RI), or the UE 115-a may transmit the indication 205 separately. In some implementations, the network entity 105-a may transmit a configuration (e.g., a layer 2 (L2) or layer 3 (L3) configuration) indicating how the UE 115-a should signal the indication 205 (e.g., in layer 1 (L1) or L2, with the CSF report or separate from the CSF report, etc.). To illustrate, self-interference may, in some examples, have semi-static characteristics, and the UE 115-a may transmit the indication 205 separately from the CSF report (e.g., which is transmitted via an L1 message) in a higher layer message (e.g., L2), while other interferences may be associated with faster dynamics, in which case transmitting the indication 205 via an L1 message may be beneficial.

In some examples, the indication 205 may include an implicit or explicit indication of a transmit power of an uplink transmission 210. In one example, the indication 205 may indicate a modulation scheme with which the UE 115-a transmitted the uplink transmission 210, and the network entity 105-a may derive a transmit power of the uplink transmission 210 based on a maximum power reduction (MPR). In another example, the indication 205 may indicate a power headroom (PHR) of the uplink transmission 210 (e.g., during processing of the downlink reference signal). In some cases, the indication 205 may include a metric of leakage associated with the uplink transmission 210 (e.g., a quantification of the impact of the self-interference). For instance, the UE 115-a may estimate an offset (e.g., a frequency offset, a power offset) indicative of a self-interference level, and the UE 115-a may include the offset in the indication 205.

In some implementations, the indication 205 may indicate whether the UE 115-a will use one or more configured grant (CG) occasions in one or more upcoming (e.g., future) slots. In some cases, the indication 205 may include an explicit indication of whether the UE 115-a will use the one or more CG occasions. In other cases, the indication 205 may include a likelihood (e.g., a probability) of whether the UE 115-a will transmit an uplink transmission 210 in the one or more CG occasions (e.g., based on a prediction of uplink traffic). In such implementations, the indication 205 may provide statistical information to the network entity 105-a regarding time slots on which there is an uplink transmission 210 by the UE 115-a that may generate potential self-interference on a reception of a downlink signal 225 at the UE 115-a. The network entity 105-a may use this statistic information to allocate a different MCS for time slots associated with potential self-interference compared to time slots unassociated with potential self-interference.

Additionally, or alternatively, the network entity 105-a may transmit signaling 230 associated with upcoming traffic to the UE 115-a to inform mitigation actions to address potential self-interference at the UE 115-a. In some examples, the network entity 105-a may indicate, to the UE 115-a, whether the network entity 105-a will use semi-persistent scheduling (SPS) occasions in upcoming (e.g., future) slots. For instance, the network entity 105-a may transmit one or more downlink signals 225 within the indicated SPS occasions. The network entity 105-a may explicitly indicate whether the network entity 105-a will use the SPS occasions, or the signaling 230 may include a statistical likelihood (e.g., a probability) that the network entity 105-a will use the SPS occasions. The UE 115-a may use the indication to determine whether, how, and/or when the UE 115-a will transmit an uplink transmission 210 to mitigate potential self-interference between the uplink transmission 210 and downlink signals 225 of the indicated SPS occasions.

In some cases, the signaling 230 may indicate whether the network entity 105-a intends to transmit one or more uplink grants (e.g., CGs) to the UE 115-a over one or more time windows. The network entity 105-a may explicitly indicate whether the network entity 105-a will transmit the one or more uplink grants over the one or more time windows, or the signaling 230 may include a statistical likelihood that the network entity 105-a will transmit the one or more uplink grants over the one or more time windows. Based on the signaling 230, the UE 115-a may suppress scheduling request (SR) transmission during the one or more time windows (e.g., or a portion of the one or more time windows if multiple time windows are indicated) to avoid potential self-interference between the SR (e.g., an uplink transmission 210) and the uplink grant (e.g., a downlink signal 225). Additionally, or alternatively, the UE 115-a may use information on the one or more uplink grants provided by the signaling 230 for CSF computation and reporting. For instance, the UE 115-a may consider self-interference when computing a CQI and an RI during the one or more time windows.

In some aspects, the network entity 105-a may allocate uplink grant (e.g., CG) resources, SRS resources, or other resources for an uplink transmission 210 on one or more time windows on which CSI-RS is allocated. The network entity 105-a may thus provide the UE 115-a with an opportunity to estimate a CQI and an RI with controlled self-interference leakage. For instance, the CSI-RS may be an example of a downlink signal 225 affected by self-interference from an uplink transmission 210, and the UE 115-a may measure a CQI and an RI associated with self-interference leakage based on receiving the CSI-RS on a same time window as the allocated resources for the uplink transmission 210. In some cases, the UE 115-a may transmit an indication 205 indicating that the CQI and the RI are measured on a slot with an active uplink transmission 210 based on the opportunity.

In some examples, a scheduled downlink signal 225 to be received by the UE 115-a may temporally overlap (e.g., at least partially) with one or more transmissions 220 (e.g., jammers) between other UEs 115 (e.g., the UE 115-b) and network entities 105 (e.g., including the network entity 105-a). The one or more transmissions 220 may be associated with nonlinear interference that potentially overlaps with the scheduled downlink signal 225. To inform mitigation actions to address the potential nonlinear interference generated by the one or more transmissions 220, the network entity 105-a may transmit an indication 215 associated with a likelihood that the one or more transmissions 220 will occur.

In some implementations, the indication 215 may include a likelihood of a transmission 220 in a portion of a carrier over a next time window. The carrier may be a carrier serving the UE 115-a or a different carrier. In some aspects, the transmission 220 may be a downlink transmission intended for another UE 115 (e.g., different from the UE 115-a), or the transmission 220 may be an uplink transmission intended for transmission by another UE 115. In some cases, the indication 215 may include a frequency offset, a power offset, or both of the transmission 220 relative to one or more carriers used by the UE 115-a.

In some cases, the network entity 105-a may exchange information related to potential transmissions 220 (e.g., uplink transmissions, downlink transmissions, or both) with one or more other network entities 105 (e.g., the information may be exchanged between cells). The information may, in some aspects, be statistical information indicating a likelihood that resources for the potential transmission 220 will be allocated within a time period, on one or more frequencies, or a combination thereof. In some examples, the network entity 105-a may then use the information for the indication 215.

Based on the exchange of the indication 205, the signaling 230, the indication 215, or any combination thereof, the UE 115-a and/or the network entity 105-a may participate in one or more interference mitigation actions to mitigate, at least partially, an effect of nonlinear interference (e.g., either self-interference from an uplink transmission 210 or nonlinear interference from one or more transmissions 220) on a scheduled downlink signal 225. In some cases, the UE 115-a may dynamically (e.g., based on network input, for example the indication 215) increase an IBW to mitigate interference from transmissions 220 (e.g., jammers) between other devices (e.g., between other UEs 115 and the network entity 105-a, between other UEs 115 and a different network entity 105). In some examples, the UE 115-a may dynamically control an AFE setpoint (e.g., a gain state, an RMS power) based on upcoming traffic patterns (e.g., uplink or downlink traffic patterns, deterministic or statistic traffic patterns) provided by the signaling 230, the indication 215, or both. The network entity 105-a may, in some cases, allocate a downlink MCS and/or rank differently for symbols (e.g., or frequency sub-bands) associated with potential interference (e.g., self-interference or jammer interference from one or more transmissions 220) than for symbols unassociated with potential interference. For example, the network entity 105-a may allocate the downlink MCS and/or rank based on a likelihood of various transmissions (e.g., jammers such as transmissions 220, uplink transmissions 210 by the UE 115-a) across the network. The likelihood may be predicted by the network entity 105-a, based on signaling (e.g., the indication 205) from the UE 115-a, based on reported predictions and statistics from UEs 115 within the network, or any combination thereof. In some implementations, the UE 115-a may transmit an SR and expect a downlink signal 225 (e.g., a downlink grant), and the UE 115-a may immediately update an AFE setpoint, an IBW, or both based on a collision between the SR and the downlink signal 225 being expected with above a threshold likelihood.

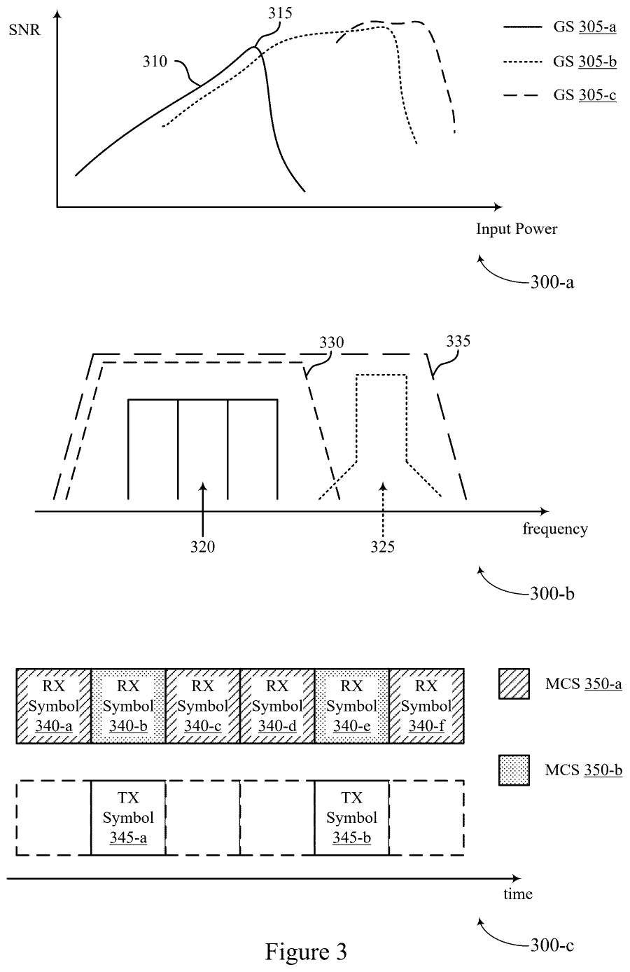

FIG. 3 shows an example of interference mitigation actions 300 that support dynamic RFFE in accordance with one or more aspects of the present disclosure. In some examples, the interference mitigation actions 300 may implement, or be implemented by, aspects of the wireless communication system 100 and the signaling configuration 200. For example, a UE 115-a and a network entity 105-a, as described with reference to FIG. 2, may participate in the interference mitigation actions 300.

In some cases, a UE may be able to adjust a receiver AFE setpoint (e.g., a gain state 305, an RMS power) to mitigate an effect of nonlinear interference on a scheduled downlink signal. In some examples, a UE may lack prior knowledge of the nonlinear interference (e.g., self-interference leakage). The UE may, in such examples, set the receiver AFE setpoint to sufficiently absorb self-interference leakage (e.g., a worst-case self-interference leakage), but the UE may experience an increased noise figure (NF) in doing so. Additionally, or alternatively, the UE 115-a may set the receiver AFE setpoint based on a case scenario without self-interference leakage, and the UE may experience a reduced NF but at the cost of a subset of transmission occasions interfering with reception slots (e.g., this may be a small subset of transmission occasions in case of sparse transmission). The UE may be able to perform various receiver AFE and/or baseband adjustments to improve an NF and mitigate an effect of nonlinear interference, but the UE may lack sufficient time to adjust the receiver AFE setpoint once the UE becomes aware of potential nonlinear interference.

Accordingly, the techniques herein support communication of advanced information on potential interfering signals, as illustrated in FIG. 2, which may allow the UE to dynamically adjust a receiver AFE setpoint to account for upcoming potential nonlinear interference in accordance with an interference mitigation action. That is, the advanced information on the potential interfering signals may provide the UE with sufficient time to adjust the receiver AFE setpoint in anticipation of the potential interfering signals. To illustrate, the UE may be able to configure a receiver AFE of the UE with a gain state 305-a, a gain state 305-b, or a gain state 305-c. Each gain state 305 may be associated with a different relationship between an SNR and an input power into the receiver AFE (e.g., into an antenna of the receiver AFE). For instance, the gain state 305-a may be associated with an AGC switch point 315 (e.g., an ideal switch point), where increases in the input power beyond the AGC switch point 315 may result in a decrease in SNR. In an ideal scenario, the UE 115-a may switch from the gain state 305-a to the gain state 305-b at the AGC switch point 315. However, a practical AGC switch point 310 for the gain state 305-a may be at a lower input power than the AGC switch point 315 due to practical constraints, such as a time for the UE to adjust the AFE setpoint (e.g., the gain state 305). Based on the advanced information on potential interfering signals, the UE may be able to dynamically switch from the gain state 305-a to the gain state 305-b closer to the AGC switch point 315. That is, the advanced information on potential interfering signals may allow the UE to dynamically adjust an AFE setpoint to mitigate an effect of nonlinear interference while reducing tradeoffs such as an increased NF.

In some cases, a UE may be able to increase an IBW of the UE (e.g., how wide a receiver AFE of the UE opens a bandwidth of the receiver AFE). The IBW may be based on a low pass filter (LPF), a band pass filter (BPF), an ADC rate, or any combination thereof. In some examples, a UE may lack advance knowledge of when interfering signals (e.g., jammers) may occur. The UE may, in such examples, set the IBW based on an L3 configuration component carrier (e.g., a minimal requirement of the component carrier configuration), but the UE may experience increased nonlinear interference (e.g., an increased impact of intermodulation product leakage) from interfering signals, which may be unobserved in the digital domain (e.g., due to filtering). Additionally, or alternatively, the UE may increase an IBW to allow the UE to apply nonlinear signal processing to measure or mitigate an impact of intermodulation product leakage generated by interfering signals. For instance, if the UE increases the IBW to detect interfering signals, the UE may be able to use a receiver linearizer, implement nonlinear interference cancellation (NLIC), increase a gain state of the receiver AFE, or any combination thereof to mitigate the impact of the interfering signals. However, the UE increasing the IBW may increase energy consumption of the UE.

Accordingly, the techniques herein support communication of advanced information on potential interfering signals, as illustrated in FIG. 2, which may allow the UE to dynamically increase the IBW to account for upcoming potential nonlinear interference in accordance with an interference mitigation action 300-b. To illustrate, the UE may receive a main signal 320 that is subject to nonlinear interference generated by a jammer 325. If the UE sets the IBW to an IBW 330, the UE may filter out the jammer 325 and thus be unable to apply nonlinear signal processing to account for the jammer 325. If the UE is aware of the jammer 325 due to the advanced information, the UE may increase the IBW to an IBW 335 that encompasses both the main signal 320 and the jammer 325, and the UE may accordingly be able to apply nonlinear signal processing to account for the jammer 325. For example, the UE may receive an indication (e.g., an indication 215 as described with reference to FIG. 2) of a likelihood that one or more transmissions (e.g., a jammer 325) between other devices of the network will occur, and the UE may set the IBW to the IBW 335 accordingly. If the UE does not receive an indication associated with the one or more transmissions, or if the one or more transmissions are unlikely to occur, the UE may maintain the IBW 330 to reduce energy consumption. That is, the UE may increase the IBW to the IBW 335 when interfering signals are expected (e.g., based on the advanced information), and the UE may maintain the IBW at the IBW 330 when interfering signals are unexpected.

In some cases, a UE may transmit on one or more symbols 345 and receive on one or more symbols 340. In some cases, a transmission on a symbol 345 could leak into one or more symbols 340. That is, a transmission on a symbol 345 may generate self-interference on a reception on one or more symbols 340 (e.g., the transmission on the symbol 345 may in some cases leak into two symbols 340 due to a difference between a transmission timeline and a reception timeline at the UE). In some aspects, the self-interference leakage may impact a partial reception frequency bandwidth or a full reception frequency bandwidth. To illustrate, the UE may receive a downlink reference signal on a symbol 340-b that overlaps with a symbol 345-a on which the UE transmits an uplink signal. The UE may report a CQI and an RI to the network based on measuring the downlink reference signal, but these measurements may be impacted by self-interference leakage from the uplink signal. However, the network may, in some examples, assume that there is no self-interference leakage, and accordingly performance may be degraded.

Accordingly, the techniques herein support communication of advanced information on potential interfering signals, as illustrated in FIG. 2, which may allow the network to allocate a downlink MCS and rank differently on symbols (e.g., or slots, or frequency sub-bands) associated with potential nonlinear interference in accordance with an interference mitigation action 300-c. To illustrate, the potential nonlinear interference may be dynamic self-interference leakage from transmissions by the UE on one or more symbols 345, and the network may dynamically allocate a downlink MCS (e.g., and rank) on symbols 340 for reception based on whether the symbols 340 overlap with symbols 345 for transmission. For instance, a symbol 340-b and a symbol 340-e for reception may overlap with a symbol 345-a and a symbol 345-b for transmission, respectively, while a symbol 340-a, a symbol 340-c, a symbol 340-d, and a symbol 340-f for reception may be unassociated with potential self-interference. The network may accordingly allocate a downlink MCS 350-a for the symbol 340-a, the symbol 340-c, the symbol 340-d, and the symbol 340-f, and a downlink MCS 350-b (e.g., which may be a reduced rank compared to the downlink MCS 350-a) for the symbol 340-b and the symbol 340-e. In cases in which the UE receives CGs for uplink transmissions, the UE may be aware of a transmission pattern of the UE, and the UE may indicate the transmission pattern to the network (e.g., an indication 205 as described with reference to FIG. 2) so that the network may dynamically allocate a downlink MCS and rank. In such cases, the UE may lack sufficient time to reconfigure a receiver AFE (e.g., in accordance with the interference mitigation action 300-a or the interference mitigation action 300-b), so the network dynamically allocating the downlink MCS and rank in accordance with the interference mitigation action 300-c may be beneficial for reducing an impact of nonlinear interference. In cases in which the UE transmits an SR and the network allocates a dynamic grant for uplink transmissions, the network may be aware of the transmission pattern of the UE and may thus be able to use the transmission pattern to dynamically allocate the downlink MCS and rank. In such cases, the UE may have sufficient time to reconfigure a receiver AFE in accordance with the interference mitigation action 300-a or the interference mitigation action 300-b.

Additionally, or alternatively, the UE may report a first CQI and a first RI based on downlink reference signal measurements that account for both measurement of the received downlink reference signal and a nonlinear transmission noise floor, and the UE may also report a delta CQI and a delta RI that indicate a potential CQI and a potential RI if the network mitigates the nonlinear transmission noise floor. To illustrate, a bandwidth of a downlink signal received at an RFFE of the UE may vary, and the nonlinear transmission noise floor may be a function of a frequency load (e.g., since a total power per symbol is dependent on a frequency allocation). If a noise floor for reception is dominated by nonlinear transmission noise, the UE may report both the potential CQI and RI as well as the delta CQI and RI to the network, and the network may use this information to mitigate an impact of self-interference (e.g., due to the nonlinear transmission noise floor) at the UE. For instance, the network may transmit a PDSCH with a reduced bandwidth (e.g., a partial frequency load), which may decrease the nonlinear transmission noise floor and thus mitigate an effect of self-interference at the UE.

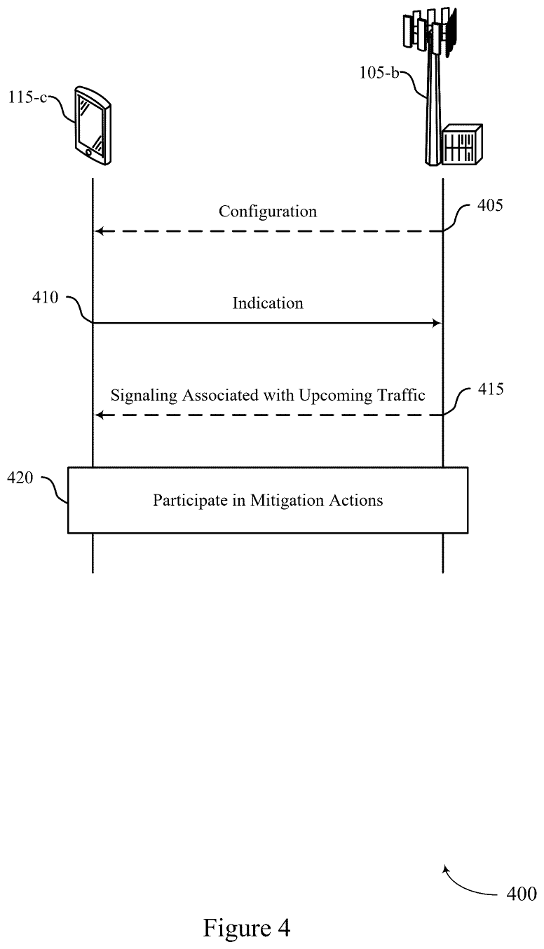

FIG. 4 shows an example of a process flow 400 that supports dynamic RFFE in accordance with one or more aspects of the present disclosure. In some aspects, the process flow 400 may implement or be implemented to realize aspects of the wireless communication system 100, the signaling configuration 200, and the interference mitigation actions 300. For example, the process flow 400 may include a UE 115-c and a network entity 105-b, which may be examples of the UE 115-a and the network entity 105-a, respectively, as illustrated in FIG. 2.

In the following description of the process flow 400, the operations between the UE 115-c and the network entity 105-b may occur in a different order than the example order shown and, in some examples, may be performed by one or more different devices other than those shown as examples. Some operations also may be omitted from the process flow 400, and other operations may be added to the process flow 400. Further, although some operations or signaling may be shown to occur at different times for discussion purposes, these operations may actually occur at the same time.

At 405, the UE 115-c may, in some examples, receive a configuration indicating a network layer for transmitting an indication of whether an uplink transmission by the UE has occurred or will occur, where the indication is associated with potential self-interference at the UE 115-c. For instance, the indication may be an indication of whether there is an uplink transmission by the UE 115-c in a slot during which CQI and RI are measured at the UE 115-c using a downlink reference signal (e.g., the indication may be an example of an indication 205 as described with reference to FIG. 2). The configuration may indicate a layer (e.g., L1 or L2) for the UE 115-c to transmit the indication, whether the UE 115-c should transmit the indication with a CSF report (e.g., including the CQI and the RI) or separately from the CSF report, or a combination thereof. To illustrate, self-interference may, in some cases, have semi-static characteristics, and the UE 115-c may transmit the indication in a higher layer message (e.g., L2) separately from an L1 CSF report, while other interferences may be associated with faster dynamics, in which case transmitting the indication via an L1 message may be beneficial. In some aspects, the network entity 105-b may transmit the configuration to the UE 115-c via L2 signaling, L3 signaling, or a combination thereof.

At 410, the UE 115-c may transmit the indication of whether the uplink transmission by the UE has occurred or will occur. In some aspects, the indication may include a metric associated with a transmit power of the uplink transmission (e.g., an implicit or explicit indication of the transmit power, such as a modulation scheme or PHR), a metric of leakage associated with the uplink transmission (e.g., a frequency offset, a power offset), a statistical likelihood of the uplink transmission, or a combination thereof. In some cases, the indication may be associated with potential self-interference between the uplink transmission and reception of a downlink reference signal at the UE 115-c, and the indication may indicate that one or more CSI measurements (e.g., a CQI, an RI) are associated with potential self-interference. For instance, the indication may be transmitted with or associated with a CSF report including the one or more CSI measurements based on the configuration received at 405. Additionally, or alternatively, the indication may indicate a statistical likelihood (e.g., between zero and one, including zero and one) that the UE 115-c will use one or more CG occasions (e.g., the uplink transmission may be associated with the one or more CG occasions). In some cases, the indication may explicitly indicate whether the UE 115-c will use the one or more CG occasions (e.g., the statistical likelihood may be either zero or one), or the indication may indicate a probability that the UE 115-c will use the one or more CG occasions (e.g., the statistical likelihood may be any value between zero and one).

At 415, the UE 115-c may, in some examples, receive (e.g., from the network entity 105-b) signaling associated with upcoming traffic between the UE 115-c and the network entity 105-b. In some implementations, the signaling may include a second indication of a statistical likelihood (e.g., between zero and one, including zero and one) that the network entity 105-c will use one or more SPS occasions, transmit one or more uplink grants over one or more time windows, or a combination thereof. The second indication may be an explicit indication (e.g., the statistical likelihood may be either zero or one), or the second indication may indicate a probability (e.g., the statistical likelihood may be any value between zero and one) that the network entity 105-c will use the one or more SPS occasions, transmit the one or more uplink grants, or both. In some aspects, the signaling may be an example of the signaling 230 as described with reference to FIG. 2.

At 420, the UE 115-c, the network entity 105-b, or both may participate in one or more mitigation actions to mitigate (e.g., at least partially) an effect of a nonlinear interference associated with the uplink transmission on a scheduled downlink signal that temporally overlaps (e.g., at least partially) with the uplink transmission. For example, the UE 115-b may increase an IBW for reception of the scheduled downlink signal (e.g., an interference mitigation action 300-b as illustrated in FIG. 3), adjust an AFE setpoint for AGC applied to reception of the scheduled downlink signal (e.g., an interference mitigation action 300-a as illustrated in FIG. 3), or both based on the indication, the signaling, or both. In some examples, the network entity 105-b may dynamically adjust a downlink MCS, a downlink rank, or both for the scheduled downlink signal based on the indication (e.g., an interference mitigation action 300-c as illustrated in FIG. 3). In some aspects, the UE 115-c may suppress transmission of an SR based on the second indication indicating that the network entity 105-c will (e.g., either explicitly or above a threshold probability) transmit the one or more uplink grants. For instance, the UE 115-c may determine that the SR may generate self-interference that may potentially affect the one or more uplink grants, and the UE 115-c may refrain from transmitting the SR accordingly (e.g., and the SR may be superfluous as the UE 115-c is already receiving one or more uplink grants based on the second indication).

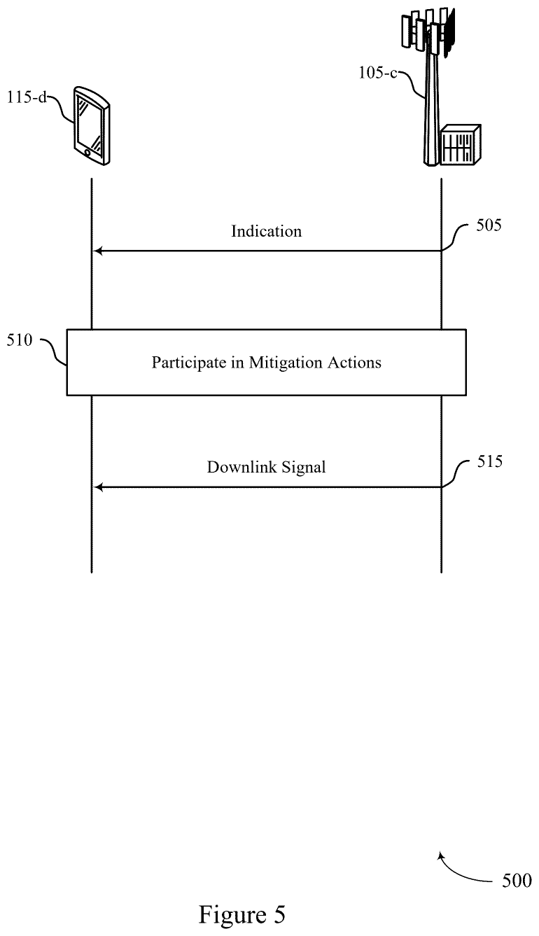

FIG. 5 shows an example of a process flow 500 that supports that supports dynamic RFFE in accordance with one or more aspects of the present disclosure. In some aspects, the process flow 500 may implement or be implemented to realize aspects of the wireless communication system 100, the signaling configuration 200, the interference mitigation actions 300, and the process flow 400. For example, the process flow 500 may include a UE 115-d and a network entity 105-c, which may be examples of the UE 115-a and the network entity 105-a, respectively, as illustrated in FIG. 2.

In the following description of the process flow 500, the operations between the UE 115-d and the network entity 105-c may occur in a different order than the example order shown and, in some examples, may be performed by one or more different devices other than those shown as examples. Some operations also may be omitted from the process flow 500, and other operations may be added to the process flow 500. Further, although some operations or signaling may be shown to occur at different times for discussion purposes, these operations may actually occur at the same time.

At 505, the UE 115-d may receive an indication associated with a likelihood (e.g., between zero and one, including zero and one) that one or more transmissions will occur. The one or more transmissions may be associated with nonlinear interference that potentially overlaps with a downlink signal at the UE 115-d, and the one or more transmissions may temporally overlap (e.g., at least partially) with the downlink signal. In some aspects, the one or more transmissions may be downlink transmissions intended for other UEs 115, uplink transmissions by other UEs 115, or other communications acting as jammers. For instance, the one or more transmissions may be examples of the transmissions 220 as described with reference to FIG. 2, and the one or more transmission may be communicated between one or more UEs 115 other than the UE 115-d and one or more network entities 105 (e.g., which may include the network entity 105-c or other network entities 105). In some aspects, the indication may be an explicit indication that the one or more transmissions will occur (e.g., the statistical likelihood may be either zero or one), or the indication may include a probability that the one or more transmissions will occur (e.g., the statistical likelihood may be any value between zero and one). In some implementations, the indication may include a frequency offset between the one or more transmissions and the downlink signal, a power offset between the one or more transmissions and the downlink signal, or both.

At 510, the UE 115-d, the network entity 105-c, or both may participate in one or more mitigation actions to mitigate (e.g., at least partially) an effect of the nonlinear interference associated with the one or more transmissions on the downlink signal. For example, the UE 115-d may increase an IBW for reception of the downlink signal (e.g., an interference mitigation action 300-b as illustrated in FIG. 3), control an AFE setpoint for AGC applied to reception of the downlink signal (e.g., an interference mitigation action 300-a as illustrated in FIG. 3), or both based on the indication.

At 515, the UE 115-d may receive, and the network entity 105-c may transmit, the downlink signal. The UE 115-d may receive the downlink signal in accordance with the one or more mitigation actions. For instance, the UE 115-d may increase an IBW for reception of the downlink signal at 510, and the UE 115-d may receive the downlink signal and the one or more transmissions within the IBW and apply nonlinear signal processing to manage and/or measure nonlinear interference (e.g., an intermodulation product) generated by the one or more transmissions.

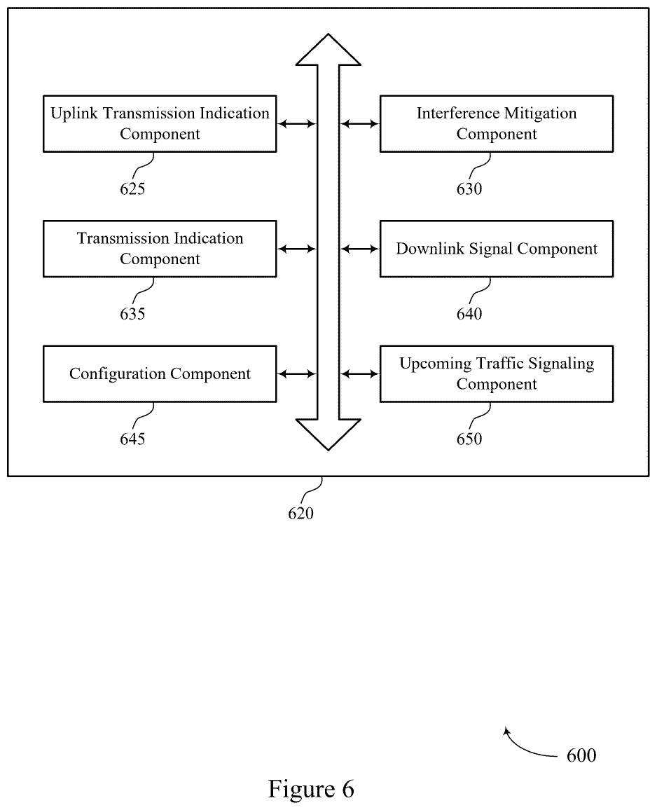

FIG. 6 shows an example 600 of a processing system 620 that supports dynamic RFFE. A processing system 620 may be an example of a processing system 140 (such as of a UE 115) and may include an uplink transmission indication component 625, an interference mitigation component 630, a transmission indication component 635, a downlink signal component 640, a configuration component 645, an upcoming traffic signaling component 650, or any combination thereof. A processing system 620, or various component thereof, may be an example of means for performing (such as a means for causing a UE 115 to perform) various techniques described herein.

The uplink transmission indication component 625 may be configured to cause the UE 115 to transmit an indication of whether an uplink transmission by the UE has occurred or will occur, where the indication is associated with potential self-interference at the UE. The interference mitigation component 630 may be configured to cause the UE 115 to participate in one or more mitigation actions to mitigate, at least partially, an effect of a nonlinear interference associated with the uplink transmission on a scheduled downlink signal that temporally overlaps, at least partially, with the uplink transmission.

In some examples, the indication includes a metric associated with a transmit power of the uplink transmission, a metric of leakage associated with the uplink transmission, a likelihood of the uplink transmission, or any combination thereof.

In some examples, the potential self-interference at the UE is between the uplink transmission by the UE and reception of a downlink reference signal at the UE. In some examples, the scheduled downlink signal is the downlink reference signal. In some examples, the indication is associated with one or more CSI measurements by the UE.

In some examples, the configuration component 645 may be configured to cause the UE 115 to receive a configuration indicating a network layer for transmitting the indication, where transmitting the indication is in accordance with the configuration.

In some examples, the indication indicates a statistical likelihood that the UE will use one or more configured grant occasions. In some examples, the uplink transmission is associated with the one or more CG occasions.

In some examples, the upcoming traffic signaling component 650 may be configured to cause the UE 115 to receive, from a network entity, signaling associated with a statistical likelihood of upcoming traffic between the UE and the network entity, where participating in the one or more mitigation actions is based on the signaling.

In some examples, to support participating in the one or more mitigation actions, the interference mitigation component 630 may be configured to cause the UE 115 to increase an IBW for reception of the scheduled downlink signal, controlling an AFE setpoint for AGC applied to reception of the scheduled downlink signal, or both based on the indication and the signaling.

In some examples, the signaling includes a second indication of a statistical likelihood that the network entity will use one or more SPS occasions. In some examples, the scheduled downlink signal is to be received during the one or more SPS occasions.

In some examples, the signaling includes a second indication of a statistical likelihood that the network entity will transmit one or more uplink grants. In some examples, the scheduled downlink signal is one of the one or more uplink grants.

In some examples, to support participating in the one or more mitigation actions, the interference mitigation component 630 may be configured to cause the UE 115 to suppress transmission of an SR based on the second indication.

Additionally, or alternatively, the transmission indication component 635 may be configured to cause the UE 115 to receive an indication associated with a likelihood that one or more transmissions will occur, where the one or more transmissions are associated with nonlinear interference that potentially overlaps with a downlink signal at the UE, where the downlink signal and at least one of the one or more transmission temporally overlap, at least partially. In some examples, the interference mitigation component 630 may be configured to cause the UE 115 to participate in one or more mitigation actions to mitigate, at least partially, an effect of the nonlinear interference on the downlink signal. The downlink signal component 640 may be configured to cause the UE 115 to receive the downlink signal in accordance with the one or more mitigation actions.

In some examples, the indication includes a frequency offset between the at least one of the one or more transmissions and the downlink signal, a power offset between the at least one of the one or more transmissions and the downlink signal, or both.

In some examples, the one or more transmissions are downlink transmissions intended for other UEs, uplink transmissions by other UEs, or a combination thereof.

In some examples, to support participating in the one or more mitigation actions, the interference mitigation component 630 may be configured to cause the UE 115 to increase an IBW for reception of the downlink signal, controlling an AFE setpoint for AGC applied to reception of the downlink signal, or both based on the indication.

A processing system 620 may include or be a component of one or more chips, systems-on-chips (SoCs), chipsets, packages, components, or devices that individually or collectively constitute or include a processing system. A processing system 620 may interface with other components of a processing system 620. For example, operations described with reference to a processing system 620, or various components thereof, may be performed by or with other such components, including a receiver, a transmitter, a transceiver, a modem, a user interface, a modulator/demodulator, an encoder/decoder, or any combination thereof (such as of the processing system 620, coupled with the processing system 620, of a processing system 620).

By including or configuring a processing system 620 for operation in a processing system 620 as described herein, the processing system 620 may support techniques for improved communication reliability, reduced power consumption, more efficient utilization of communication resources, improved coordination between devices, and longer battery life.

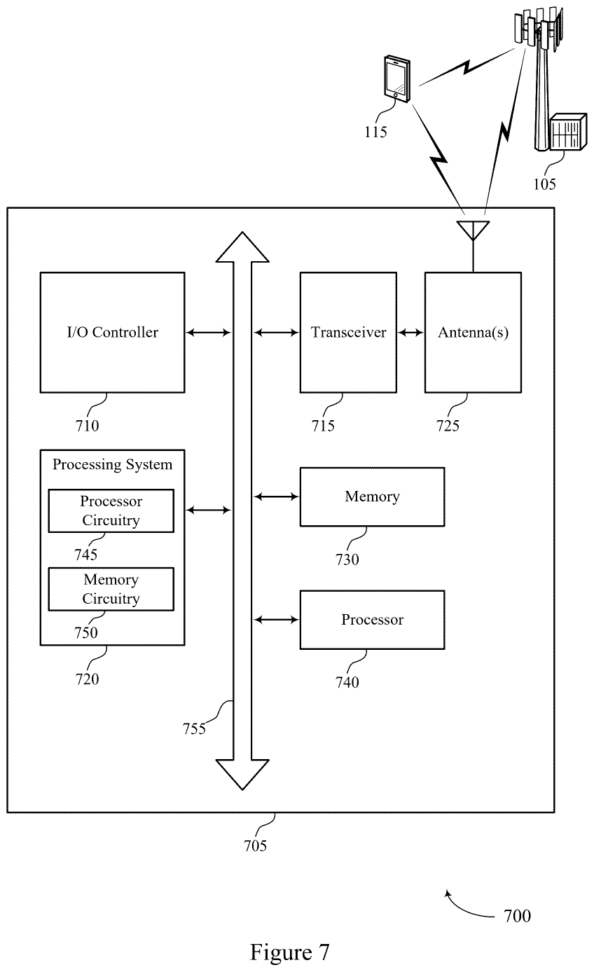

FIG. 7 shows an example of a system 700 including a device 705 that supports dynamic RFFE. The device 705 may be an example of or include components of UE 115. The device 705 may communicate (such as wirelessly) with one or more other devices (such as network entities 105, UEs 115). The device 705 may include components for transmitting and receiving communication, which may include a processing system 720, an input/output (I/O) controller, such as an I/O controller 710, a transceiver 715, antenna(s) 725, a memory 730, and a processor 740. Components of the device 705 may be coupled (such as operatively, communicatively, functionally, electronically, electrically, in electronic communication) a bus 755.

The transceiver 715 may support bi-directional communication via antenna(s) 725, and may support transmission operations, reception operations, or both, as described herein. The transceiver 715 may implement functionality of a modem (such as a wireless modem) and may include one or more RF chains. An RF chain may include one or more filters, mixers, oscillators, amplifiers, ADCs, and other components that convert between an analog signal (such as for transmission or reception via an air interface) and a digital signal (such as for digital processing at the device 705). The transceiver 715 may modulate symbols and provide the modulated symbols to antenna(s) 725 for transmission, and demodulate symbols from signals received using antenna(s) 725.

The processor 740 may be a general-purpose processing component that supports various operations (such as applications) of the device 705. The memory 730 may be a general-purpose storage component that stores code executable by the processor 740. Such code may include instructions that, when executed by the processor 740, cause the device 705 to perform various functions (such as to support an application of the device 705). The I/O controller 710 may manage inputs and outputs for the device 705, may manage peripherals not integrated into the device 705, or may represent a physical connection (such as port) to an external peripheral. The processor 740 may interact with a modem, a keyboard, a mouse, a touchscreen, or other device (such as via I/O controller 710). In some implementations, a user may interact with the device 705 via the I/O controller 710 or via hardware components controlled by the I/O controller 710.

The processing system 720 may be an example of a processing system 140 or a processing system 620. For example, the processing system 720 may include processor circuitry 745 and memory circuitry 750 that stores code, and may be configured to cause the device 705 to perform operations that support dynamic radio frequency front end. Although the processing system 720 is illustrated as a separate component, which may involve a separate chip, chipset, or other module, in some implementations, one or more functions described with reference to the processing system 720 may be supported by or performed by a transceiver 715, antenna(s) 725, a processor 740, memory 730, or any combination thereof, such that a processing system 720 may include one or more of a transceiver 715, antenna(s) 725, a processor 740, memory 730, or any combination thereof.

By including or configuring the processing system 720 for operation in the device 705 as described herein, may support techniques for improved communication reliability, reduced power consumption, more efficient utilization of communication resources, improved coordination between devices, and longer battery life.

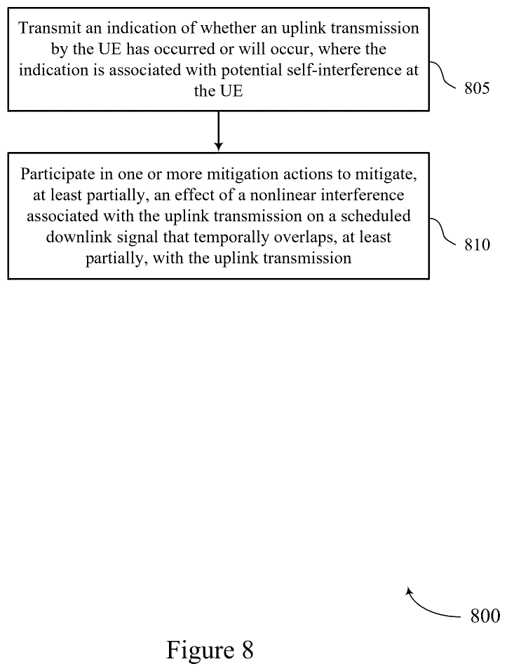

FIG. 8 shows an example of a method 800 that supports dynamic RFFE. Operations of the method 800 may be performed by a UE or its components (such as using a processing system configured to cause the UE 115 to perform one or more of the operations) as described herein.

At 805, the method may include transmitting an indication of whether an uplink transmission by the UE has occurred or will occur, where the indication is associated with potential self-interference at the UE. In some examples, aspects of the operations of 805 may be performed by an uplink transmission indication component 625.

At 810, the method may include participating in one or more mitigation actions to mitigate, at least partially, an effect of a nonlinear interference associated with the uplink transmission on a scheduled downlink signal that temporally overlaps, at least partially, with the uplink transmission. In some examples, aspects of the operations of 810 may be performed by an interference mitigation component 630.

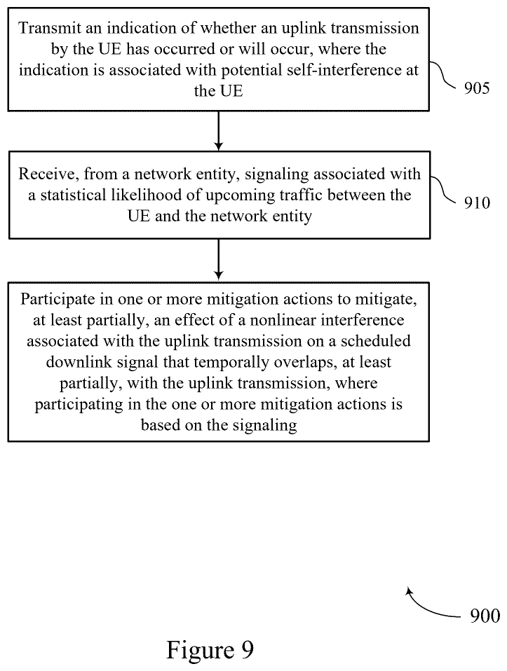

FIG. 9 shows an example of a method 900 that supports dynamic RFFE. Operations of the method 900 may be performed by a UE or its components (such as using a processing system configured to cause the UE 115 to perform one or more of the operations) as described herein.

At 905, the method may include transmitting an indication of whether an uplink transmission by the UE has occurred or will occur, where the indication is associated with potential self-interference at the UE. In some examples, aspects of the operations of 905 may be performed by an uplink transmission indication component 625.

At 910, the method may include receiving, from a network entity, signaling associated with a statistical likelihood of upcoming traffic between the UE and the network entity. In some examples, aspects of the operations of 910 may be performed by an upcoming traffic signaling component 650.

At 915, the method may include participating in one or more mitigation actions to mitigate, at least partially, an effect of a nonlinear interference associated with the uplink transmission on a scheduled downlink signal that temporally overlaps, at least partially, with the uplink transmission, where participating in the one or more mitigation actions is based on the signaling. In some examples, aspects of the operations of 915 may be performed by an interference mitigation component 630.

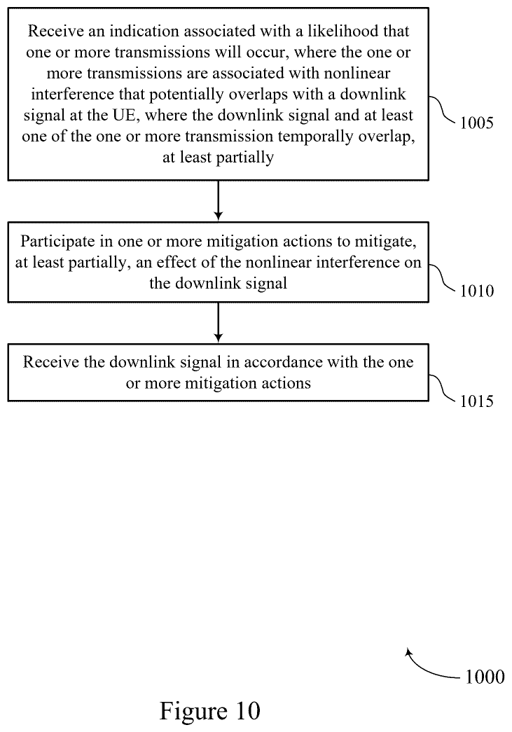

FIG. 10 shows an example of a method 1000 that supports dynamic RFFE. Operations of the method 1000 may be performed by a UE or its components (such as using a processing system configured to cause the UE 115 to perform one or more of the operations) as described herein.

At 1005, the method may include receiving an indication associated with a likelihood that one or more transmissions will occur, where the one or more transmissions are associated with nonlinear interference that potentially overlaps with a downlink signal at the UE, where the downlink signal and at least one of the one or more transmission temporally overlap, at least partially. In some examples, aspects of the operations of 1005 may be performed by a transmission indication component 635.

At 1010, the method may include participating in one or more mitigation actions to mitigate, at least partially, an effect of the nonlinear interference on the downlink signal. In some examples, aspects of the operations of 1010 may be performed by an interference mitigation component 630.

At 1015, the method may include receiving the downlink signal in accordance with the one or more mitigation actions. In some examples, aspects of the operations of 1015 may be performed by a downlink signal component 640.

Implementation examples are described in the following numbered clauses:
Aspect 1: A method for wireless communication by a UE, comprising: transmitting an indication of whether an uplink transmission by the UE has occurred or will occur, wherein the indication is associated with potential self-interference at the UE; and participating in one or more mitigation actions to mitigate, at least partially, an effect of a nonlinear interference associated with the uplink transmission on a scheduled downlink signal that temporally overlaps, at least partially, with the uplink transmission.
Aspect 2: The method of aspect 1, wherein the indication comprises a metric associated with a transmit power of the uplink transmission, a metric of leakage associated with the uplink transmission, a likelihood of the uplink transmission, or any combination thereof.
Aspect 3: The method of any of aspects 1 through 2, wherein the potential self-interference at the UE is between the uplink transmission by the UE and reception of a downlink reference signal at the UE, the scheduled downlink signal is the downlink reference signal, and the indication is associated with one or more CSI measurements by the UE.
Aspect 4: The method of any of aspects 1 through 3, further comprising: receiving a configuration indicating a network layer for transmitting the indication, wherein transmitting the indication is in accordance with the configuration.
Aspect 5: The method of any of aspects 1 through 4, wherein the indication indicates a statistical likelihood that the UE will use one or more CG occasions, and the uplink transmission is associated with the one or more CG occasions.
Aspect 6: The method of any of aspects 1 through 5, further comprising: receiving, from a network entity, signaling associated with a statistical likelihood of upcoming traffic between the UE and the network entity, wherein participating in the one or more mitigation actions is based at least in part on the signaling.
Aspect 7: The method of aspect 6, wherein participating in the one or more mitigation actions comprises: increasing an IBW for reception of the scheduled downlink signal, controlling an AFE setpoint for AGC applied to reception of the scheduled downlink signal, or both based at least in part on the indication and the signaling.
Aspect 8: The method of any of aspects 6 through 7, wherein the signaling comprises a second indication of a statistical likelihood that the network entity will use one or more SPS occasions, the scheduled downlink signal is to be received during the one or more SPS occasions.
Aspect 9: The method of any of aspects 6 through 8, wherein the signaling comprises a second indication of a statistical likelihood that the network entity will transmit one or more uplink grants, the scheduled downlink signal is one of the one or more uplink grants.
Aspect 10: The method of aspect 9, wherein participating in the one or more mitigation actions comprises: suppressing transmission of an SR based at least in part on the second indication.
Aspect 11: A method for wireless communication by a UE, comprising: receiving an indication associated with a likelihood that one or more transmissions will occur, wherein the one or more transmissions are associated with nonlinear interference that potentially overlaps with a downlink signal at the UE, wherein the downlink signal and at least one of the one or more transmission temporally overlap, at least partially; participating in one or more mitigation actions to mitigate, at least partially, an effect of the nonlinear interference on the downlink signal; and receiving the downlink signal in accordance with the one or more mitigation actions.
Aspect 12: The method of aspect 11, wherein the indication comprises a frequency offset between the at least one of the one or more transmissions and the downlink signal, a power offset between the at least one of the one or more transmissions and the downlink signal, or both.
Aspect 13: The method of any of aspects 11 through 12, wherein the one or more transmissions are downlink transmissions intended for other UEs, uplink transmissions by other UEs, or a combination thereof.
Aspect 14: The method of any of aspects 11 through 13, wherein participating in the one or more mitigation actions comprises: increasing an instantaneous bandwidth for reception of the downlink signal, controlling an AFE setpoint for AGC applied to reception of the downlink signal, or both based at least in part on the indication.
Aspect 15: A UE for wireless communication, comprising a processing system that includes processor circuitry and memory circuitry that stores code, the processing system configured to cause the UE to perform a method of any of aspects 1 through 10.
Aspect 16: A UE for wireless communication, comprising at least one means for performing a method of any of aspects 1 through 10.
Aspect 17: A non-transitory computer-readable medium storing code for wireless communication, the code comprising instructions executable by one or more processors to perform a method of any of aspects 1 through 10.
Aspect 18: A UE for wireless communication, comprising a processing system that includes processor circuitry and memory circuitry that stores code, the processing system configured to cause the UE to perform a method of any of aspects 11 through 14.
Aspect 19: A UE for wireless communication, comprising at least one means for performing a method of any of aspects 11 through 14.
Aspect 20: A non-transitory computer-readable medium storing code for wireless communication, the code comprising instructions executable by one or more processors to perform a method of any of aspects 11 through 14.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit an indication of whether an uplink transmission by the UE has occurred or will occur, wherein the indication is associated with potential self-interference at the UE; and
participate in one or more mitigation actions to mitigate, at least partially, an effect of a nonlinear interference associated with the uplink transmission on a scheduled downlink signal that temporally overlaps, at least partially, with the uplink transmission.

2. The UE of claim 1, wherein the indication comprises a metric associated with a transmit power of the uplink transmission, a metric of leakage associated with the uplink transmission, a likelihood of the uplink transmission, or any combination thereof.

3. The UE of claim 1, wherein the potential self-interference at the UE is between the uplink transmission by the UE and reception of a downlink reference signal at the UE, wherein the scheduled downlink signal is the downlink reference signal, and wherein the indication is associated with one or more channel state information measurements by the UE.

4. The UE of claim 1, wherein the one or more processors are individually or collectively further operable to execute the code to cause the UE to:
receive a configuration indicating a network layer for transmitting the indication, wherein transmitting the indication is in accordance with the configuration.

5. The UE of claim 1, wherein the indication indicates a statistical likelihood that the UE will use one or more configured grant occasions, and wherein the uplink transmission is associated with the one or more configured grant occasions.

6. The UE of claim 1, wherein the one or more processors are individually or collectively further operable to execute the code to cause the UE to:
receive, from a network entity, signaling associated with a statistical likelihood of upcoming traffic between the UE and the network entity, wherein participating in the one or more mitigation actions is based at least in part on the signaling.

7. The UE of claim 6, wherein, to participate in the one or more mitigation actions, the one or more processors are individually or collectively operable to execute the code to cause the UE to:
increase an instantaneous bandwidth for reception of the scheduled downlink signal, controlling an analog front end setpoint for automatic gain control applied to reception of the scheduled downlink signal, or both based at least in part on the indication and the signaling.

8. The UE of claim 6, wherein:
the signaling comprises a second indication of a statistical likelihood that the network entity will use one or more semi-persistent scheduling occasions, wherein the scheduled downlink signal is to be received during the one or more semi-persistent scheduling occasions.

9. The UE of claim 6, wherein the signaling comprises a second indication of a statistical likelihood that the network entity will transmit one or more uplink grants, wherein the scheduled downlink signal is one of the one or more uplink grants.

10. The UE of claim 9, wherein, to participate in the one or more mitigation actions, the one or more processors are individually or collectively operable to execute the code to cause the UE to:
suppress transmission of a scheduling request based at least in part on the second indication.

11. A user equipment (UE), comprising:
one or more memories storing processor-executable code; and
one or more processors coupled with the one or more memories and individually or collectively operable to execute the code to cause the UE to:
receive an indication associated with a likelihood that one or more transmissions will occur, wherein the one or more transmissions are associated with nonlinear interference that potentially overlaps with a downlink signal at the UE, wherein the downlink signal and at least one of the one or more transmissions temporally overlap, at least partially;
participate in one or more mitigation actions to mitigate, at least partially, an effect of the nonlinear interference on the downlink signal; and
receive the downlink signal in accordance with the one or more mitigation actions.

12. The UE of claim 11, wherein the indication comprises a frequency offset between the at least one of the one or more transmissions and the downlink signal, a power offset between the at least one of the one or more transmissions and the downlink signal, or both.

13. The UE of claim 11, wherein the one or more transmissions are downlink transmissions intended for other UEs, uplink transmissions by other UEs, or a combination thereof.

14. The UE of claim 11, wherein, to participate in the one or more mitigation actions, the one or more processors are individually or collectively operable to execute the code to cause the UE to:
increase an instantaneous bandwidth for reception of the downlink signal, controlling an analog front end setpoint for automatic gain control applied to reception of the downlink signal, or both based at least in part on the indication.

15. A method for wireless communication by a user equipment (UE), comprising:
transmitting an indication of whether an uplink transmission by the UE has occurred or will occur, wherein the indication is associated with potential self-interference at the UE; and
participating in one or more mitigation actions to mitigate, at least partially, an effect of a nonlinear interference associated with the uplink transmission on a scheduled downlink signal that temporally overlaps, at least partially, with the uplink transmission.

16. The method of claim 15, wherein the potential self-interference at the UE is between the uplink transmission by the UE and reception of a downlink reference signal at the UE, wherein the scheduled downlink signal is the downlink reference signal, and wherein the indication is associated with one or more channel state information measurements by the UE.

17. The method of claim 15, further comprising:
receiving a configuration indicating a network layer for transmitting the indication, wherein transmitting the indication is in accordance with the configuration.

18. The method of claim 15, wherein the indication indicates a statistical likelihood that the UE will use one or more configured grant occasions, and wherein the uplink transmission is associated with the one or more configured grant occasions.

19. The method of claim 15, further comprising:
receiving, from a network entity, signaling associated with a statistical likelihood of upcoming traffic between the UE and the network entity, wherein participating in the one or more mitigation actions is based at least in part on the signaling.

20. The method of claim 19, wherein the signaling comprises a second indication of a statistical likelihood that the network entity will use one or more semi-persistent scheduling occasions, and wherein the scheduled downlink signal is to be received during the one or more semi-persistent scheduling occasions.
